(19) United States
(12) Patent Application Publication
(10) Pub. No.: US 2025/0254114 A1
(43) Pub. Date: Aug. 7, 2025

(54) ALARM SYSTEM FOR MONITORING NETWORK DEVICES ON A VIRTUALIZATION PLATFORM

(71) Applicant: GENESIS TECHNOLOGY (USA) INC., Phoenix, AZ (US)

(72) Inventors: Po-Hsien CHIU, Hsinchu City (TW); Chung-Hsien KAO, Hsinchu City (TW)

(73) Assignee: GENESIS TECHNOLOGY (USA) INC., Phoenix, AZ (US)

(21) Appl. No.: 19/028,252

(22) Filed: Jan. 17, 2025

(30) Foreign Application Priority Data
Feb. 6, 2024 (TW) 113201452

(51) Int. Cl. H04L 43/10; H04L 43/20

(52) U.S. Cl. CPC H04L 43/10; H04L 43/20

(57) ABSTRACT

An alarm system for monitoring network devices on a virtualization platform includes a cloud server and a monitoring server on different client platforms. Each monitoring server includes modules respectively for log management, status testing, status monitoring, and signal transmission. Logs from network devices are analyzed for an alarm event, regular test signals are sent for respectively determining the network devices are in operation, and status information is received and for determining whether the network devices are in an abnormal status. The module for signal transmission sends data from the other modules to the cloud server. The alarm system can comprehensively monitor the network devices and send alarms back to the cloud server, thereby immediately dispatching engineers to repair the network devices.

### BACKGROUND OF THE INVENTION

This application claims priority for the TW patent application Ser. No. 11/320,1452 filed on 6 Feb. 2024, the content of which is incorporated by reference in its entirely.

### Field of the Invention

The present invention relates to a field for monitoring networks, particularly to an alarm system for monitoring network devices on a virtualization platform.

### Description of the Related Art

The local network of an information electronics company usually contains multiple network devices. In current technology, when an abnormality occurs in a network device, such as disconnecting from a network cable or having damaged parts, the customer who finds that the network device needs to be repaired initiatively contacts the manufacturer. The manufacturer will then dispatch engineers to go to the site for maintenance. Alternatively, the engineer will regularly inspect and maintain the network devices.

However, the network devices cannot be repaired in time and some abnormalities may not immediately shut down the devices but have affected the performance of the devices. Therefore, if the status of each network device can be automatically detected by the monitoring system and the abnormality of the network device can be detected and engineers are automatically dispatched before the customer finds the abnormality of the network device, the shutdown of network devices at a client terminal will be effectively avoided. In addition, when the number of the network devices at the client terminal expands significantly, how to quickly adjust the performance of the monitoring system to cooperate with the devices whose number is huge is also an important issue.

To overcome the abovementioned problems and satisfy the requirements in the future, the present invention provides an alarm system for monitoring network devices on a virtualization platform. The embodiments of the alarm system are detailed as follows.

### SUMMARY OF THE INVENTION

An objective of the present invention is to provide an alarm system for monitoring network devices on a virtualization platform, which actively obtains the statuses of network devices, passively obtains the logs of the network devices, comprehensively monitors the network devices, determines whether the network devices are in an abnormal status, and sends alarms back to a cloud server, thereby immediately dispatching engineers to repair the network devices.

Another objective of the present invention is to provide an alarm system for monitoring network devices on a virtualization platform, which is deployed on different virtualization platforms of a client terminal. Based on the characteristics of virtualization, the arrangement of hardware computing resources is adjusted according to environmental conditions. When the number of the monitored network devices increases or decreases, the hardware computing resources of the monitoring server will be expanded or reduced.

In order to achieve the foregoing objectives, the present invention provides an alarm system for monitoring network devices on a virtualization platform, which includes at least one monitoring server and a cloud server. The monitoring server is arranged on at least one client platform and configured to monitor network devices on the client platform. The monitoring server includes a log managing module, a status testing module, a status monitoring module, a signal transmission module, and a connection device. The log managing module is configured to receive logs sent by the network devices and determine whether the logs contain an alarm event. The status testing module is configured to regularly send a test signal to each of the network devices and determine whether the network devices are in operation based on a test response returned by the network devices. The status monitoring module is configured to receive the status information of the network devices and determine whether the network devices are in an abnormal status. The signal transmission module is connected to the log managing module, the status testing module, and the status monitoring module and configured to send out information received by the log managing module, the status testing module, and the status monitoring module from the network devices and information generated by the log managing module, the status testing module, and the status monitoring module. The connection device is connected to the log managing module, the status testing module, the status monitoring module, and the network devices and configured to send the test signal to the network devices and receive the test response, the logs, and the status information transmitted by the network devices. The connection device includes an actively receiving module and a passively receiving module. The actively receiving module is configured to obtain the status information from the network devices based on a simple network management protocol (SNMP) and provide the status information for the status monitoring module. The passively receiving module is configured to receive the logs sent by the network devices based on a system logging protocol (Syslog) and provide the logs for the log managing module. The cloud server is connected to the monitoring server through the signal transmission module and configured to receive and store information sent by the signal transmission module.

In an embodiment of the present invention, the log managing module is configured to set keywords and determine whether the logs include at least one of the keywords to determine whether there is the alarm event.

In an embodiment of the present invention, the signal transmission module in the monitoring server is connected to the cloud server through a web server interface (WebAPI).

In an embodiment of the present invention, the signal transmission module is configured to send information received by the log managing module, the status testing module, and the status monitoring module from the network devices and information generated by the log managing module, the status testing module, and the status monitoring module to the cloud server by e-mail.

In an embodiment of the present invention, the client server is implemented with identical or different virtualization platforms.

In an embodiment of the present invention, the status monitoring module is further configured to determine whether the number of the network devices has been expanded based on the status information of the network devices. When the number of the network devices is expanded, the computing resources of the monitoring server are correspondingly expanded.

In an embodiment of the present invention, the computing resources of the monitoring server include the number of cores of at least one central processor and capacities of at least one memory and at least one hard disk space.

In an embodiment of the present invention, when the cloud server receives the alarm event or information related to abnormal statuses of the network devices, the cloud server automatically sends a dispatch notification to equipment maintenance personnel.

### BRIEF DESCRIPTION OF THE DRAWINGS

FIG. 1 is a diagram schematically illustrating an alarm system for monitoring network devices on a virtualization platform according to an embodiment of the present invention; and

FIG. 2 is a diagram schematically illustrating an alarm system for monitoring network devices on a virtualization platform according to another embodiment of the present invention.

### DETAILED DESCRIPTION OF THE INVENTION

The technical solutions in the embodiments of the present invention will be clearly and completely described below with reference to the drawings in the embodiments of the present invention. Obviously, the described embodiments are part of the embodiments of the present invention, not all of the embodiments. Based on the embodiments of the present invention, all other embodiments obtained by those skilled in the art without making inventive efforts should be included within the scope of the present invention.

It should be understood that, when used in this specification and the scope of the claims, the terms “comprising” and “including” refer to the presence of a stated feature, whole, step, operation, element, and/or component, but does not exclude the presence or addition of one or more other features, wholes, steps, operations, elements, components and/or combinations of these.

It should also be understood that the terms used in the specification of the present invention is only used to describe particular embodiments but not intended to limit the present invention. As used in this specification and the claims, the singular forms “a,” “an,” and “the” are intended to include the plural forms unless the context clearly dictates otherwise.

It should further be understood that the terms “and/or” used in the specification and the claims refer to any and all possible combinations of one or more of the associated listed items and include these combinations.

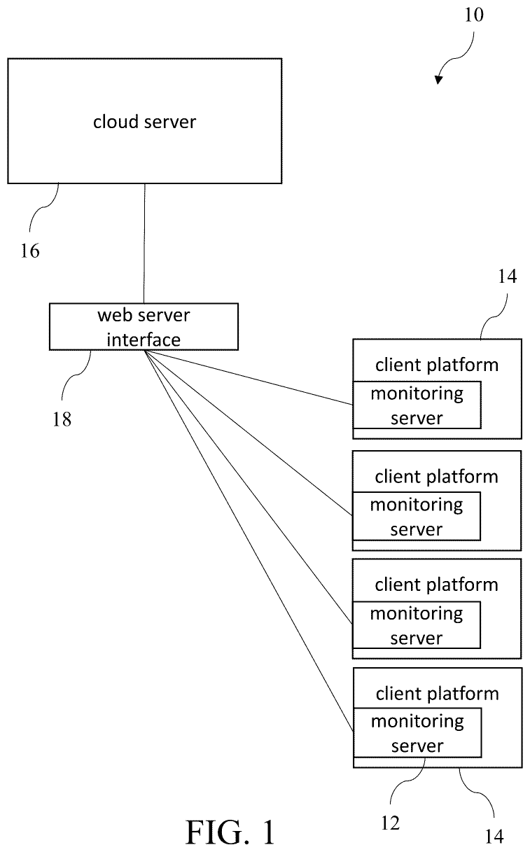

The present invention provides an alarm system for monitoring network devices on a virtualization platform, which monitors the internal network devices of different customers (such as different companies, different factories) and transmits the information of all the network devices back to the cloud server of the equipment maintenance manufacturer for management. When the cloud server receives an alarm event, appropriate maintenance engineers will be automatically dispatched to a client terminal where the alarm event occurred to repair the network devices. Please refer to FIG. 1. FIG. 1 is a diagram schematically illustrating an alarm system 10 for monitoring network devices on a virtualization platform according to an embodiment of the present invention. The alarm system 10 for monitoring network devices on a virtualization platform includes at least one monitoring server 12 and a cloud platform 16. When there are multiple monitoring servers 12, the monitoring servers 12 are respectively arranged on different client platforms 14. The client platforms 14 are implemented with local networks of different companies. The monitoring server 12 monitors network devices (not illustrated) on the client platform 14. The network devices include servers, routers, exchangers, or firewalls. The monitoring server 12 is connected to the cloud server 16 through a web server interface (WebAPI) 18.

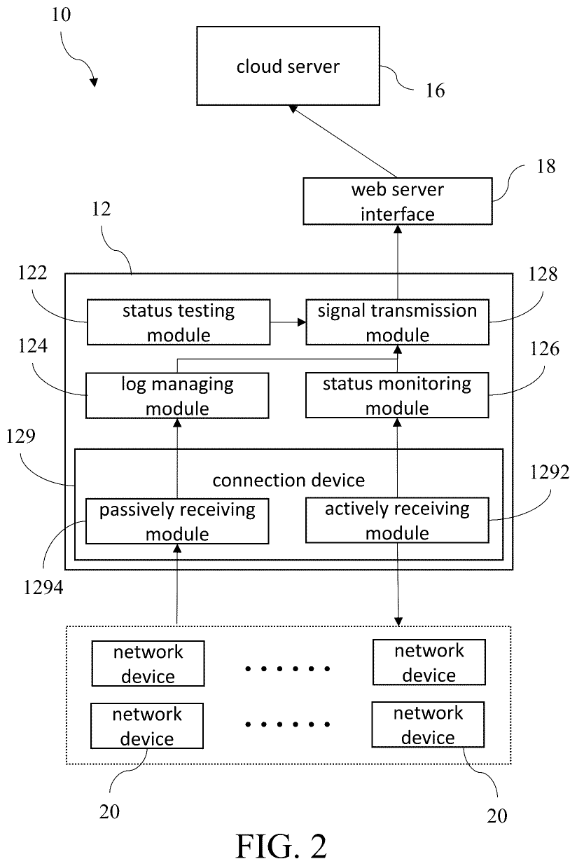

Please refer to FIG. 2. FIG. 2 is a diagram schematically illustrating an alarm system 10 for monitoring network devices on a virtualization platform according to another embodiment of the present invention. The monitoring server 12 includes a status testing module 122, a log managing module 124, a status monitoring module 126, and a signal transmission module 128. The signal transmission module 128 is connected to the status testing module 122, the log managing module 124, and the status monitoring module 126. The signal transmission module 128 is connected to the cloud server 16 through the web server interface 18. The status testing module 122 determines whether the network devices 20 are in operation. For example, the status testing module 122 regularly sends a test signal to each of the network devices 20. When the network device 20 is in operation, a test response is returned by the network device 20. When the network device 20 returns a test response, the network device 20 is not in operation, such as an offline mode or a shutdown mode. The log managing module 124 receives logs sent by the network devices 20 and determines whether the logs contain an alarm event. Furthermore, the log managing module 124 sets keywords and determines whether the logs returned by the network device 20 include the keyword. When any log includes the keyword, the alarm event occurs in the network device 20 that returns the log. The status monitoring module 126 receives the status information of the network devices 20 and determines whether the network devices 20 are in an abnormal status. The status information can be the status of hardware devices, such as device lists (including model, device name, IP address, serial number, version, the life cycle of products, etc.), performance of computing resources such as CPU, hard disk space, and memory, the failure of hardware equipment, password changed without authorization, etc. The signal transmission module 128 sends out information received by the log managing module 124, the status testing module 122, and the status monitoring module 126 from the network devices 20 and information generated by the log managing module 124, the status testing module 122, and the status monitoring module 126.

The monitoring server 12 further includes a connection device 129 connected to the log managing module 124, the status testing module 122, the status monitoring module 126, and the network devices 20. The connection device 129 sends the test signal sent by the status testing module 122 to the network devices 20, receives the test response returned by the network device 20, and transmits the test response to the status testing module 122. Besides, the connection device 129 further receives the logs and the status information transmitted by the network devices 20. Furthermore, the connection device 129 includes an actively receiving module 1292 and a passively receiving module 1294. The actively receiving module 1292 obtains the status information from the network devices 20 based on a simple network management protocol (SNMP) and provides the status information for the status monitoring module 126. The passively receiving module 1294 passively receives the logs sent by the network devices 20 based on a system logging protocol (Syslog) and provides the logs for the log managing module 124.

The statuses of some network devices 20 are actively obtained by the status monitoring module 126 and passively transmitted to the log managing module 124. Thus, the partial functions of the log managing module 124 are the same as the partial functions of the status monitoring module 126. For example, when the network device 20 is disconnected from a network cable, the status monitoring module 126 determines that the status of the network device 20 is abnormal and sends an alarm. When the log managing module 124 analyzes the log, the log managing module 124 identifies the alarm event indicating that the network device 20 has no signal. Simultaneously, the status testing module 122 determines that the network device 20 is not in operation and sends an alarm since the status testing module 122 does not receive the test response returned by the network device 20. The alarm events and the information indicating the abnormal status of the network device 20 are transmitted to the cloud server 16. The cloud server 16 automatically sends a dispatch notification to the equipment maintenance personnel responsible for the alarm event.

Since some client platforms 14 strictly manage the outward transmission of information to avoid the leakage of secrets, the monitoring server 12 cannot directly transmit alarms to the cloud server 16 through the network. Therefore, the signal transmission module 128 of the present invention will firstly determine whether the network environment of the client platform 14 has the restrictions of information security. If not, the information received by the log managing module 124, the status testing module 122, and the status monitoring module 126 will from the network device 20 and the information generated by the log managing module 124, the status testing module 122, and the status monitoring module 126 are directly transmitted to the cloud server 16 through the network. However, if there are the restrictions of information security, they will be transmitted to the cloud server 16 via e-mail instead.

In addition, the client platforms 14 are implemented with identical or different virtualization platforms. The expansion of resources is computed based on the characteristics of virtualization. Thus, system computing amount can be adjusted according to environmental conditions. The status monitoring module 126 determines whether the number of network devices 20 has been expanded based on the status information of the network device 20. When there are a huge number of monitored targets, the status monitoring module 126 can correspondingly expand the computing resources of the monitoring server 1, such as providing more CPU-related resources (e.g., the number of cores) or the capacity of memory or hard disk space in a timely manner. When the number of monitored targets is less, the status monitoring module 126 can correspondingly reduce the computing resources of the hardware. For example, when the original number of network devices 20 is only 7, the allocated computing resources include a 2-core CPU, 256 GB hard disk space, and 4G memory capacity. When the number of network devices 20 is expanded to 500, the status monitoring module 126 will automatically adjust the computing resources used for monitoring to include an 8-core CPU, 2TB hard disk space, and 16G memory capacity.

According to the embodiments provided above, the alarm system for monitoring network devices on a virtualization platform, which actively obtains the statuses of network devices based on the SNMP communication protocol, passively obtains the logs of the network devices based on the Syslog communication protocol, comprehensively monitors the network devices, determines whether the network devices are in an abnormal status, and sends alarms back to the cloud server, thereby immediately dispatching engineers to repair the network devices. Besides, the present invention is deployed on different virtualization platforms of a client terminal. Based on the characteristics of virtualization, the arrangement of hardware computing resources is adjusted according to environmental conditions. When the number of the monitored network devices increases or decreases, the hardware computing resources of the monitoring server will be expanded or reduced.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An alarm system for monitoring network devices on a virtualization platform, the alarm system comprising:
at least one monitoring server, arranged on at least one client platform and configured to monitor network devices on the at least one client platform, comprising:
a log managing module configured to receive logs sent by the network devices and determine whether the logs contain an alarm event;
a status testing module configured to regularly send a test signal to each of the network devices and determine whether the network devices are in operation based on a test response returned by the network devices;
a status monitoring module configured to receive status information of the network devices and determine whether the network devices are in an abnormal status;
a signal transmission module connected to the log managing module, the status testing module, and the status monitoring module and configured to send out information received by the log managing module, the status testing module, and the status monitoring module from the network devices and information generated by the log managing module, the status testing module, and the status monitoring module; and
a connection device connected to the log managing module, the status testing module, the status monitoring module, and the network devices and configured to send the test signal to the network devices and receive the test response, the logs, and the status information transmitted by the network devices, wherein the connection device comprises:
an actively receiving module configured to obtain the status information from the network devices based on a simple network management protocol (SNMP) and provide the status information for the status monitoring module; and
a passively receiving module configured to receive the logs sent by the network devices based on a system logging protocol (Syslog) and provide the logs for the log managing module; and
a cloud server connected to the at least one monitoring server through the signal transmission module and configured to receive and store information sent by the signal transmission module.

2. The alarm system for monitoring network devices on a virtualization platform according to claim 1, wherein the log managing module is configured to set keywords and determine whether the logs include at least one of the keywords to determine whether there is the alarm event.

3. The alarm system for monitoring network devices on a virtualization platform according to claim 1, wherein the signal transmission module in the at least one monitoring server is connected to the cloud server through a web server interface (WebAPI).

4. The alarm system for monitoring network devices on a virtualization platform according to claims 1, wherein the signal transmission module is configured to send information received by the log managing module, the status testing module, and the status monitoring module from the network devices and information generated by the log managing module, the status testing module, and the status monitoring module to the cloud server by e-mail.

5. The alarm system for monitoring network devices on a virtualization platform according to claims 3, wherein the signal transmission module is configured to send information received by the log managing module, the status testing module, and the status monitoring module from the network devices and information generated by the log managing module, the status testing module, and the status monitoring module to the cloud server by e-mail.

6. The alarm system for monitoring network devices on a virtualization platform according to claim 1, wherein the at least one client server is implemented with identical or different virtualization platforms.

7. The alarm system for monitoring network devices on a virtualization platform according to claim 1, wherein the status monitoring module is further configured to determine whether number of the network devices has been expanded based on the status information of the network devices, and when the number of the network devices is expanded, computing resources of the monitoring server are correspondingly expanded.

8. The alarm system for monitoring network devices on a virtualization platform according to claim 7, wherein the computing resources of the monitoring server include number of cores of at least one central processor and capacities of at least one memory and at least one hard disk space.

9. The alarm system for monitoring network devices on a virtualization platform according to claim 1, wherein when the cloud server receives the alarm event or information related to abnormal statuses of the network devices, the cloud server automatically sends a dispatch notification to equipment maintenance personnel.
